(19) United States
(12) Patent Application Publication
(10) Pub. No.: US 2008/0069599 A1
(43) Pub. Date: Mar. 20, 2008

(54) IMAGE FORMING METHOD, IMAGE FORMING APPARATUS, AND PROCESS CARTRIDGE

(76) Inventors: Minoru Nakamura, Takarazuka-shi (JP); Akira Izutani, Osaka (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 11/854,783

(22) Filed: Sep. 13, 2007

(30) Foreign Application Priority Data
Sep. 15, 2006 (JP) 2006-250174

(51) Int. Cl. G03G 15/08

(52) U.S. Cl. 399/281

(57) ABSTRACT

To provide an image forming method that includes supplying a toner to a developing roller using a toner supplying roller, and forming an image by the use of a one-component developer, wherein the toner supplying roller contains a polyurethane foam and is 5 mm to 12 mm in diameter, the polyurethane foam has an repulsion force of 100 g/mm to 400 g/mm, and the average cell diameter, or Dc, of the polyurethane foam and the volume average particle diameter, or Dt, of the toner satisfy the following mathematical expressions:

4≦Dt≦10

30Dt+50≦Dc≦30Dt+300
where Dt and Dc are in micrometer.

### BACKGROUND OF THE INVENTION

1. Field of the Invention

The present invention relates to an image forming method and apparatus in which a developer containing an electrostatic image developing toner is used, and also relates to a process cartridge.

2. Description of the Related Art

In recent years, toners whose particles have a smaller diameter for forming finer images have been developed; unfortunately, as the flowability of these toners decreases with decreasing diameter of the toner particles, such toners tend to have lower flowability. Such lower flowability prevents the toner particles from contacting a charging member, resulting in uneven charge of toner particles and occurrence of background smear. Those problems associated with lower flowability are particularly conspicuous when a toner contains a releasing agent such as a wax. The term “background smear” means a phenomenon that a transfer material such as paper is contaminated when toner particles are insufficiently charged and then the particles are transferred to unintended image areas in developing a latent electrostatic image. The above-stated problems associated with lower chargeability are further conspicuous in full-color toners to be used in full-color image forming apparatuses.

From the viewpoint of limited available space and installing them with less concern for locations, image forming apparatuses/printers have been required to be small in size. In particular, demands for downsizing tend to be conspicuous in a printer equipped with a one-component developing device which brings a great advantage in downsizing of a printer. With downsizing these apparatuses, respective components used inside these apparatuses need to be small in size, and the same applies to a toner conveyance mechanism in a developing device, which unfortunately causing the below-mentioned problems. With smaller diameter of a developing roller used for developing an image on an image bearing member using a toner and smaller diameter of a toner supplying roller for supplying a toner to the developing roller, the amount of toner particles that are supplied from the toner supplying roller decreases to an insufficient level, the followability to the required amount of toner is lowered, resulting in nonuniformity in image density. The problem with low followability of toner caused by such smaller diameter of a toner supplying roller is conspicuous with a toner having a smaller diameter. The problem is further significant in a toner containing a releasing agent such as wax. Second, frequent appearances of image noises such as (image) streaks are caused by the difficulty of removing toner particles from the developing roller. The problem is caused because toner particles on the developing roller go through a nip portion between a developing roller and a toner supplying roller at so short intervals that the particles cannot completely recovery from the shape deformed at the nip portion, as a result of their smaller diameter of the developing roller that require the roller run at higher rotation speed. The problems with low followability of toner caused by smaller diameter of toner supplying rollers appear more frequently with toners whose particles have a smaller diameter. The problems are further significant in toners containing a releasing agent such as wax.

As a means to solve the foregoing problems, Japanese Patent (JP-B) No. 3001913 proposes the following techniques: particles of the proposed toner are super fine particles of 10 μm or smaller in diameter; at least surface layer of at least one of the proposed toner supplying roller and the developing roller is formed with polyurethane form; the cell diameter of that polyurethane form is in the range of 30 μm to 200 μm. With this configuration, troubles caused by significant degradation in image qualities can be prevented.

According to the proposed technique in JP-B No. 3010990, the technique allows for a stable supply amount of toner and developing images with stability and printing images with less trouble with toner fogging. The proposed technique is characterized in that the average cell diameter at least in the maximum image area width of a toner supplying roller is in the range of 50 μm to 200 μm; Rmax which is the degree of surface roughness at the maximum image area width of a toner image bearing member is in the range of 2 μm to 15 μm; the surface of the toner image bearing member is rough like saw blade; the toner supplying roller is arranged to contact the developing roller such that the rollers rotates in the opposite direction to each other and the saw-blade surface faces in the opposite direction by the contact rotation with the toner supplying roller.

According to the toner supplying roller proposed in Japanese Patent Application Laid-Open No. 2002-6618, the proposed toner supplying roller enables to form images having nonuniform image density and nonuniform pitches. The proposed roller is characterized in that it is covered with a foam having an average cell diameter of 20 μm to 200 μm, an average cell number of 25 per 1 mm² to 260 per 1 mm², and compression spring constant of the roller is in the range of from 0.25 N/mm to 5.0 N/mm.

Unfortunately, when that proposed toner supplying roller is relatively small in diameter and used for supplying a one-component developer in a full-color image forming apparatus, the toner supplying roller may not supply sufficient amount of toner particles to a developing roller. Nonuniformity in image density frequently occurs in images having a large solid portion which requires a large amount of toner.

### BRIEF SUMMARY OF THE INVENTION

The present invention is to provide an image forming method, an image forming apparatus and a process cartridge each of which enables to stably supply a toner to a photoconductor regardless of the amount of toner used for developing an image, and is excellent in fixing performance of the image in a fixing step by thermally fixing the toner images without using oil and is also excellent in quality of the image fixed on a recording material without causing nonuniform image density and image streaks.

The means to solve the aforementioned problems are:

<1> An image forming method including supplying a toner to a developing roller using a toner supplying roller, and forming an image by the use of a one-component developer, wherein the toner supplying roller contains a polyurethane foam and is 5 mm to 12 mm in diameter, the polyurethane foam has an repulsion force of 100 g/mm to 400 g/mm, and the average cell diameter, or Dc, of the polyurethane foam and the volume average particle diameter, or Dt, of the toner satisfy the following mathematical expressions:

4≦Dt≦10

30Dt+50≦Dc≦30Dt+300

where Dt and Dc are in micrometer.

<2> The image forming method according to the item <1>, wherein the developing roller makes contact with the toner supplying roller, and and the contact portion is formed such that the surface of the toner supplying roller has concave portions.

<3> The image forming method according to the item <1>, wherein the developing roller is larger in diameter and has a smaller circumferential velocity than the toner supplying roller.

<4> The image forming method according to the item <1>, wherein the developing roller rotates in the counter direction to the rotational direction of the toner supplying roller.

<5> The image forming method according to the item <1>, wherein the polyurethane foam contains at least a polyol, an isocyanate, a catalyst and a foaming agent.

<6> The image forming method according to the item <1>, wherein the toner contains at least a binder resin, a colorant and a releasing agent.

<7> An image forming apparatus including a developing roller, and a toner supplying roller configured to feed a toner to the surface of the developing roller to thereby form an image by the use of a one-component developer, wherein the toner supplying roller contains a polyurethane foam and is 5 mm to 12 mm in diameter, the polyurethane foam has an repulsion force of 100 g/mm to 400 g/mm, and the average cell diameter, or Dc, of the polyurethane foam and the volume average particle diameter, or Dt, of the toner satisfy the following mathematical expressions:

4≦Dt≦10

30Dt+50≦Dc≦30Dt+300

where Dt and Dc are in micrometer.

<8> The image forming apparatus according to the item <7>, wherein the developing roller makes contact with the toner supplying roller, and the contact portion is formed such that the surface of the toner supplying roller has concave portions.

<9> The image forming apparatus according to the item <7>, where in the developing roller is larger in diameter and has a smaller circumferential velocity than the toner supplying roller.

<10> The image forming apparatus according to the item <7>, wherein the developing roller rotates in the counter direction to the rotational direction of the toner supplying roller.

<11> The image forming apparatus according to the item <7>, wherein the polyurethane foam contains at least a polyol, an isocyanate, a catalyst and a foaming agent.

<12> The image forming apparatus according to the item <7>, wherein the toner contains at least a binder resin, a colorant and a releasing agent.

<13> A process cartridge including a developing unit wherein the developing unit is equipped with a developing roller and a toner supplying roller configured to supply a toner to the surface of the developing roller, the developing roller and the toner supplying roller are integrated into a one unit and is detachably mountable to the main body of an image forming apparatus; the toner supplying roller contains a polyurethane foam and is 5mm to 12mm in diameter, the polyurethane foam has an repulsion force of 100 g/mm to 400 g/mm, and the average cell diameter, or Dc, of the polyurethane foam and the volume average particle diameter, or Dt, of the toner satisfy the following mathematical expressions:

4≦Dt≦10

30Dt+50≦Dc≦30Dt+300

where Dt and Dc are in micrometer.

<14> The process cartridge according to the item <13>, wherein the developing roller makes contact with the toner supplying roller, and the contact portion is formed such that the surface of the toner supplying roller has concave portions.

<15> The process cartridge according to the item <13>, wherein the developing roller is larger in diameter and has a smaller circumferential velocity than the toner supplying roller.

<16> The process cartridge according to the item <13>, wherein the developing roller rotates in the counter direction to the rotational direction of the toner supplying roller.

<17> The process cartridge according to the item <13>, wherein the polyurethane foam contains at least a polyol, an isocyanate, a catalyst and a foaming agent.

<18> The process cartridge according to the item <13>, wherein the toner contains at least a binder resin, a colorant and a releasing agent.

According to the present invention, the toner supplying roller that is used in one-component developing process is small in external diameter. That is, its external diameter is in the range of from 5 mm to 12 mm. When the external diameter is smaller than 5 mm, the core rod in the toner supplying roller may not have sufficient strength, disabling to stably supply a toner. In contrast, when the diameter is larger than 12 mm, it is unfavorable because the toner supplying roller is too large in diameter to make it difficult to achieve downsizing image forming apparatuses.

According to the present invention, the repulsion force of the toner supplying roller is in the range of 100 g/mm to 400 g/mm. When the repulsion force of the toner supplying roller is lower than 100 g/mm, the hardness of the surface is insufficient, and thus the surface can be easily worn out by the friction between the surfaces of the toner supplying roller and a developing roller. In contrast, when the repulsion force is larger than 400 g/mm, this excessively hard surface will apply an excessively large stress to a toner residing in the gap between the toner supplying roller and a developing roller when the toner supplying roller makes contact with the developing roller. In such a case, the toner particles to which that excessive pressure is applied may go into cells at the surface of the toner supplying roller, causing the hardening and toner filming. Consequently the surface of the toner supplying roller easily suffers from occurrence of image noises such as streaks.

According to the present invention, the average cell diameter Dc (μm) of the polyurethane foam and the volume average diameter Dt (μm) of the toner satisfy the mathematical expression 1, where Dc and Dt are in μm. When the cell diameter Dc of the polyurethane foam is smaller than (30Dt+50), the amount of toner entered in the cells is decreased. In such a case, the toner supplying roller cannot stably supply toner particles to the developing roller. This phenomenon is conspicuous in toner supplying rollers having a smaller diameter in which the circumferential length thereof is short, and the phenomenon is further conspicuous to cause low toner followability when printing an image having a large portion of solid images that require a large amount of toner. When the cell diameter Dc of the polyurethane foam is larger than (30Dt+300), a residual toner is hardly removed. This problem is caused because a toner supplying roller having a smaller diameter has naturally a greater curvature, and a residual toner remaining on a developing roller is hardly removed. It was found that these values are linked to the particle diameter of the toner used, the cell diameter Dc varies in accordance with the toner particle diameter, and the relation between the cell diameter of a toner supplying roller and the particle diameter of toner is important in supplying a toner.

In the image forming method according to claims 1 to 5 of the present invention, the characteristics of the toner supplying roller and the diameter of the toner particles are suitably controlled, and thus occurrence of nonuniformity of image density and image streaks occurred in formation of images can be prevented.

In an image forming method according to claim 6, the component composition of resins used in toner is controlled, which makes it possible to improve fixing ability in a fixing process where images are thermally fixed without using oil.

According to claims 7 to 18 in the present invention, the image forming apparatus and process cartridge are suitably used with a variety of electrophotographic developers.

### BRIEF DESCRIPTION OF THE SEVERAL VIEWS OF THE DRAWINGS

FIG. 1 is a schematic view exemplarily showing an image forming apparatus of the present invention.

FIG. 2 is a schematic view showing an example of the process cartridge of the present invention.

FIG. 3 is an illustration showing that the relation between the average cell diameter of the foam in a toner supplying roller and the toner particle diameter affects the supplied amount of the toner and the toner removability.

### DETAILED DESCRIPTION OF THE INVENTION

Hereafter, the method for manufacturing a toner supplying roller will be explained. For example, the following method is exemplified. A cored bar is set in a die, a composition containing a rubber raw material is foamed and formed in the die to thereby form a sponge layer being concentric with the cored bar on the circumferential part of the cored bar. In this case, molding conditions for forming the sponge layer such as molding pressure and molding temperature (die temperature) may be suitably determined in accordance with the type of components used such as rubber raw material and foam material and the composition of the rubber raw material composition and foam materials. In another method to manufacture the toner supplying roller, a foam block having a hole in which the a cored bar has been inserted and fixed with, for example, an adhesive is shaped into a roller in cutting-work. When making the toner supplying roller a multi-layered so as to have two or more layers, a method in which the surface of the roller prepared as described above is covered around with a foam sheet used as a second-tier layer and the foam sheet is fixed with an adhesive; and a method in which the surface of the roller is coated with a foam material and the foam is hardened, are exemplified.

Mechanical frothing as well as chemical foaming are commonly known for forming a polyurethane foam. In mechanical frothing, a polyurethane foam is formed by generating air bubbles without using any foaming agent but by sending a gas to materials being kneaded or mixed, and heating and curing the resulting material with air bubbles. In chemical foaming, a polyurethane foam is formed by adding a foaming agent such as water, which reacts with isocyanate and generates air bubbles, to various materials, while balancing out a curing reaction of used resins.

By mixing a predetermined amount of water as a chemically foaming agent with a composition of raw materials produced by mechanical froth method and by using an amine compound and an organic acid salt as catalysts, it is possible for the polyurethane foam according to the present invention to have characteristics of those formed by mechanical frothing method as well as characteristics of those formed by chemical foaming method. With this configuration, the cell diameter is controllable within a range of 180 μm to 500 μm.

Examples of elastomeric foam include ester polyurethane foams; ether polyurethane foams; and rubber foam materials such as nitrile rubber, ethylene propylene rubber, ethylene propylene diene rubber, styrene butadiene rubber, butadiene rubber, isoprene rubber, natural rubber, silicone rubber, acrylic rubber, chloroprene rubber, butyl rubber, and epichlorhydrin rubber. Of those materials, ester polyurethane foams and ether polyurethane foams are preferable. Each of these may be used alone or in combination with two or more. In addition, silicone oil may be mixed into the above-mentioned foam material(s) or applied over the surface of the resulting foam in order to adjust the friction drag coefficient of the foam at a suitable level.

The elastomeric foam can be formed by pouring a mixture composed of adequate amount of polyol (a), isocyanate (b), a catalyst (c) and a foaming agent (d) into a die which is preliminarily fixed at a predetermined position and keeping it under room temperature for 24 hours to harden the mixture. Polyol (a) for the elastomeric foam can be selected from those that are generally used for forming urethane foams. Such polyol (a) is suitably selected for use so as to provide at lo least a glass transition temperature in each of the ranges, −70° C. to −20° C. and 0° C. to 60° C., in the obtained urethane foam.

Polyol (a) is preferably at least one selected from among poly oxyalkylene polyols, vinyl polymer containing-poly oxyalkylene polyols, and polyester polyols. Examples of the poly oxyalkylene polyols include initiators including water, alcohols, amines and ammonias to which alkylene oxide is added. Examples of the alcohols as the initiators include monovalent or higher alcohols including monovalent alcohols such as methanol and ethanol; bivalent alcohols such as ethylene glycol and propylene glycol; trivalent alcohols such as glycerin and trimethylolpropane; quadrivalent alcohols such as pentaerythritol; hexavalent alcohols such as sorbitol; and octavalent alcohols such as sucrose. Examples of the amines as the initiators include monovalent or higher amines including monovalent amines such as dimethylamine and diethylamine; bivalent amines such methylamine as and ethylamine; trivalent amines such as monoethanolamine, diethanolamine, and triethanolamine; quadrivalent amines such as ethylenediamine; and pentavalent amines such as diethylenetriamine. Of those initiators, monovalent to hexavalent alcohols and monovalent to pentavalent amines are preferable.

As alkylene oxide, for example, ethylene oxide, propylene oxide, or 1,2-, 1,3-, 1,4-, or 2,3-butylene oxide can be used. Each of these can be used alone or in combination. Among them, the propyleneoxide and/or ethylene oxide are preferable. When used in combination, they can be added in block- or random-reaction; in such a case, block addition reaction is preferable.

Examples of the vinyl polymer containing-polyoxy alkylene polyol include vinyl monomers, such as acrylonitrile and styrene, polymerized and dispersed in the above-mentioned polyoxy alkylene polyol under the existence of radical. The content of the vinyl polymer in the polyoxy alkylene polyol is generally in the range of from 15% by mass to 45% by mass.

Examples of the polyester polyol include those obtained by polycondensation of one or more compounds (A) and one or more compounds (B) and those obtained by open-ring polymerization such as ε-caprolactone, where compounds (A) are those having two or more hydroxyl groups such as ethylene glycol, diethylene glycol, triethylene glycol, 1,2-propylene glycol, trimethylene glycol, 1,3 or 1,4-butylene glycol, hexamethylene glycol, decamethyleneglycol, glycerol, trimethylolpropane, pentaerythritol and sorbitol and compounds (B) are those having two or more carboxyl groups such as adipic acid, succinic acid, malonic acid, maleic acid, tartaric acid, pimelic acid, sebacic acid, phthalic acid, terephthalic acid, isophthalic acid and trimellitic acid

Polyol (a) preferably contains polyol A-1 and polyol A-2, where polyol A-1 has: an average number of functional groups of 1.5 to 4.5; and, a hydroxyl value of 20 mgKOH/g to 70 mgKOH/g (where it is preferably in the range of 30 mgKOH/g to 60 mgKOH/g), and polyol A-2 has: an average number of functional groups of 1.5 to 4.5; a hydroxyl value of 140 mgKOH/g to 300 mgKOH/g (where it is further preferably in the range of 200 mgKOH/g to 270 mgKOH/g). When the average number of functional groups is less than 1.5, the resulting urethane foam may be weak against dryness and heat, and thus permanent deformations of the foam may be easily caused. And when that is larger than 4.5, the extensibility of the resulting urethane foam is lowered while the hardness thereof is increased, and thus physical properties such as tensile strength is lowered. By using both polyol A-1 and A-2 each having a different hydroxyl value, i.e, a polyol (A-1) having a hydroxyl value of 20 mgKOH/g to 70 mgKOH/g and a polyol (A-2) having a hydroxyl value of 140 mgKOH/g to 300 mgKOH/g, it is possible to easily form an urethane foam having at least a glass transition temperature in each of the ranges, −70° C. to −20° C. and 0° C. to 60° C.

Isocyanate (b) can be selected from known polyisocyanates that are generally used for urethane foams. Examples of such polyisocyanates include aromatic polyisocyanates such as 2,4- or 2,6-tolylene diisocyanate (toluene diisocyanate; TDI), diphenylmethane diisocyanate (MDI), phenylene diisocyanate (PDI), and naphthalene diisocyanate (NDI); aromatic-aliphatic polyisocyanates such as 1,3- or 1,4-xylylene diisocyanate (XDI); aliphatic polyisocyanates such as hexamethylene diisocyanate (HDI); alicyclic polyisocyanates such as 3-isocyanate methyl-3,5,5-trimethyl cyclohexylisocyanate (IPDI), 4,4′-methylenebis(cyclohexylisocyanate) (H12MDI), and 1,3- or 1,4-bis(isocyanate methyl) cyclohexane (H6XDI); carbodiimide modified polyisocyanates; biuret modified polyisocyanates; allophanate modified polyisocyanates; dimers; trimers; and, polymethylene polyphenyl polyisocyanate (cured MDI or polymeric MDI). These may be used alone or in combination. Among those, the aromatic polyisocyanates are preferable. And TDI is further preferable.

Catalyst (c) can be selected from known ones that are generally used for urethane foams. Examples of such catalysts include tertiary amines such as triethylamine, triethylenediamine, and N-methyl morpholine; quarternary ammonium salts such as tetrethyl hydroxyl ammonium; amine catalysts such as imidazole and 2-ethyl-4-methylimidazole; and organic metal catalysts such as organic tin compounds (such as tin acetate, octylacid tin, dibutyltin dilaurate, and dibutyltin chloride), organic lead compounds (such as lead octylate and lead naphthenate), and organic nickel compounds (such as nickel naphthenate). Of these catalysts, it is preferred that an amine catalyst and an organic metal catalyst be used in combination; using a tertiary amine and an organic tin compound in combination is particularly preferable.

Larger amount of amine catalysts contained increases air bubbles generated in the foam. Larger amount of organic tin compounds contained increases the hardness of the resin.

Foaming agent (d) can be selected from known ones that are generally used for urethane foams. Examples of such foaming agents include foaming agents based on water and/or halogenation substitutes of aliphatic hydrocarbon. Examples of such foaming agents based on the substitutes include trichlorofluoromethane, dichlorodifluoromethane, trichloroethane, trichloroethylene, tetrachloroethylene, methylene chloride, trichlorotrifluoroethane, dibromotetrafluoroethane, and carbon tetrachloride. Those may be used alone or in combination; in the present invention, using water alone is preferable.

The elastomeric foam used in the present invention may be electrically conductive. Such conductive elastomeric foam can be formed of a conductive foaming material into which an adequate conductive agent is added.

For a conductive agent to be added when imparting conductivity to the elastomeric foam, an ion conductive agent and an electron conductive agent can be used. Examples of the ion conductive agent include perchlorates such as tetraethylammonium, tetrabutyl ammonium, dodecyl trimethyl ammoniums (such as lauryl trimethyl ammonium), hexadecyl trimethyl ammonium, octadecyltrimethyl ammnoniums (such as stearyl trimethyl ammonium), and fatty acid modified dimethyl ethyl ammonium; ammonium salts such as chlorates, hydrochloride, bromate, iodate, fluoroboric acid salt, sulfate, ethyl-sulfuric-acid salt, carboxylates, and sulfonates; alkali metals such as lithium, sodium, potassium, calcium, magnesium; perchlorates, chlorates, hydrochlorides, bromate, iodate, fluoroboric acid salt, trifluoromethylsulfuric acid salt, or sulfonates of or alkaline earth metal.

Examples of the electron conductive agent include conductive carbons such as Ketjenblack and acetylene black; carbons such as ISAF, HAF, FEF, GPF, SRF and FT used in rubber; carbons used in inks, thermally decomposed carbons, natural graphite, artificial graphite which are subjected to an oxidization treatment; oxidized conductive metals such as nickel, tin oxide, titanium oxide, and zinc oxide; and metals such as copper, silver, and germanium. Those conductive agents may be used alone or in combination.

The added amount of the conductive agent is not particularly limited; the added amount of the ion conductive agent is generally in the range of 0.01 parts by mass to 5.0 parts by mass, and preferably in the range of 0.05 parts by mass to 2 parts by mass to 100 parts by mass of the elastomeric foam. The added amount of the electron conductive agent is generally in the range of 1 part by mass to 50 parts by mass, and preferably in the range of 5 parts by mass to 40 parts by mass to 100 parts by mass of the elastomeric foam. In addition to the above-stated conductive agent, other suitable additives selected from, for example, known filler(s) and/or cross-linking agent(s) to be used for rubber may be added to the conductive elastomeric foam in accordance with the necessity.

In addition, appropriate amount of other suitable additives such as resistance-adjusting agent(s), foam stabilizer(s), and flame retardant(s) may be added in the urethane foam in the present invention.

The image forming apparatus of the present invention will be described hereafter.

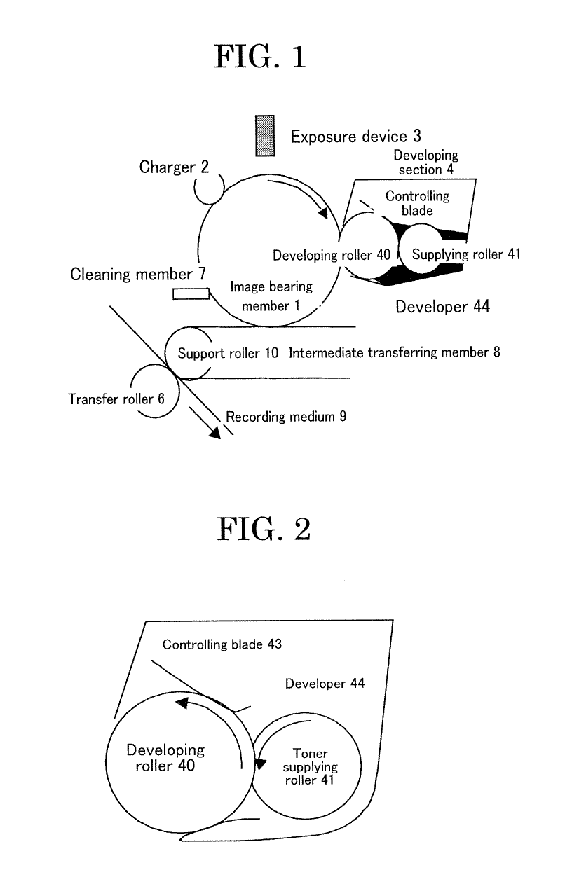

FIG. 1 schematically shows an embodiment of the image forming apparatus of the present invention. The surface of an image bearing member 1 (or photoconductor 1) is charged on a charging unit 2. On the thus charged surface, a latent image is formed with an exposure device 3. Bias is applied on the surfaces of a developing roller 40 and the image bearing member 1 so that the latent image is formed into a visible image with a developer 44 supplied from the developing roller 40. The developer 44 is supplied on the surface of the developing roller 40 from a toner supplying roller 41 at which the two rollers contact each other. The developer 44 is thinned and uniformly spread over the surface of the developing roller 40 with a controlling blade 42.

The visible image is once transferred onto an intermediate transferring member 8, and then transferred onto a recording medium 9 such as paper. The image on the recording medium 9 is thermally fixed with a fixing roller. The developer 44 remains on the latent image after the transferring of the latent image to the intermediate transferring medium 8 in a short period of time. The remaining developer is removed and collected with a cleaning member 7.

The developing section will be described hereinafter.

FIG. 2 is a schematic view showing an example of the developing apparatus (process cartridge) of the present invention. A developer (toner) 44 is contained in a toner supplying unit in a container (not shown). The developer 44 is stirred by a toner supplying roller 41 and carried on a nip portion of a developing roller 40. A controlling blade 43 is provided to control the amount of toner on the surface of the developing roller 40 to form a toner thin layer thereon. Thus, toner particles passed where the controlling blade 43 makes contact with the developing roller 40 form a thin layer. The toner on the surface of the developing roller 40 is given friction when passing through the nip portion between the toner supplying roller 41 and the developing roller 40 and a gap between the controlling blade 43 and the developing roller 40 so that the charged amount of toner is adjusted at an adequate level. Particularly in a system where a cleaning unit is not provided, it is essential that sufficient amount of remaining toner particles that are collected from the surface of an image bearing member by the developing roller 40 can be removed from the surface of the developing roller 40 by the toner supplying roller 41. This is because in such a system, the difference between the actual charged amount of the toner and the adequate level tends to be large, and so a toner collected by a developing roller must be removed by a toner supplying roller.

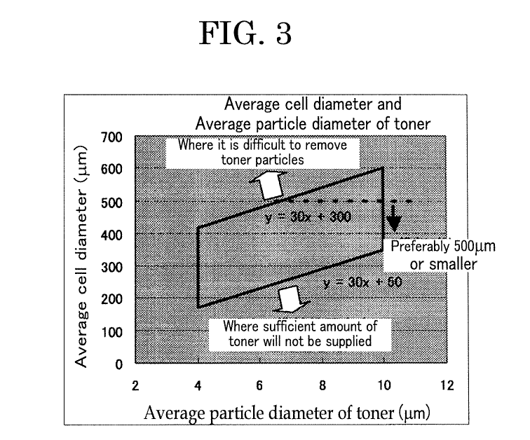

FIG. 3 is an illustration showing that the relation between the average cell diameter of the foam in a toner supplying roller and the toner particle diameter affects the supplied amount of the toner and the toner removability.

The characteristics of the toner were measured as described below.

### <Measurement Method>

### (Particle Diameter)

The measurement method of particle size distribution of the toner particles will be explained.

Examples of the measuring equipment for particle size distribution of the toner particles by Coulter counter method include Coulter counter TA-II and Coulter multisizer II (both of which are manufactured by Beckman Coulter, Inc.). The measurement method will be described below.

First, 0.1 mL to 5 mL of a surfactant as the dispersing agent (preferably alkylbenzene sulfonate salt) is added to 100 mL to 150 mL of an electrolytic aqueous solution. Here, the electrolytic solution is an aqueous solution of about 1% NaCl prepared using a primary sodium chloride, and by the means of, for example, ISOTON-II (supplied from Coulter). Then, 2 mg to 20 mg in solid content of a sample to be measured is further added thereto. The electrolytic aqueous solution in which the sample has been suspended is subjected to a dispersion treatment for about 1 to 3 minutes using an ultrasonic dispersing machine, and the toner particles or the volume of the toner, and the number of the toner particles are measured using an aperture of 100 m in diameter as the aperture through the use of the aforementioned measurement apparatus to thereby calculate the volume distribution and the number distribution based on the values measured as above. The volume average particle diameter (Dv) and number average particle diameter (Dp) can be obtained from the obtained distributions.

As used channels, 13 channels of 2.00 μm to less than 2.52 μm, 2.52 μm to less than 3.17 μm, 3.17 μm to less than 4.00 μm, 4.00 μm to less than 5.04 μm, 5.04 μm to less than 6.35 μm, 6.35 μm to less than 8.00 μm, 8.00 m to less than 10.08 μm, 10.08μm to less than 12.70μm, 12.70 μm to less than 16.00 μm, 16.00 μm to less than 20.20 μm, 20.20 μm to less than 25.40 μm, 25.40 μm to less than 32.00 μm and 32.00 μm to less than 40.30 μm are used, and the particles having a particle diameter ranging from 2.00 μm to less than 40.30 μm are intended to use.

### —Average Degree of Circularity—

In a suitable method of measuring the shapes of toner particles, a CCD camera is used to optically detect and analyze particles contained in the suspension liquid containing toner particles by passing the suspension liquid through an optical detection band on a plate. The average degree of circularity is obtained by dividing the circumferential length of a circle having an area equivalent to the resulting projected area by the real circumferential length of a particle.

The average circularity can be measured with FPIA-2000, a Flow Particle Image Analyzer. In the specific measurement method, 0.1 mL to 0.5 mL of a surfactant as a dispersing agent, preferably an alkylbenzene sulfonate salt, is added to 100 mL to 150 mL of water (from which impurities have been previously removed) in a vessel, and 0.1 g to 0.5 g of a sample to be measured is further added to the resulting solution. A suspension liquid in which the sample has been dispersed is subjected to a dispersion treatment using an ultrasonic dispersing machine for about 1 to 3 minutes to thereby control the concentration of the dispersion ranging from 3,000/μL to 10,000/μL, and the average degree of circularity of the toner particles are measured using the above-stated apparatus.

The average cell diameter and repulsion force of the toner supplying roller were measured as described below.

(Measurement of Average Cell Diameter): The surface of the toner supplying roller was visually observed with an optical microscope having a magnification of 50 times to determine the number of cells on a 30 mm straight line. The average cell diameter was calculated by dividing the resulting number by the length of the straight line. (Repulsion Force): An aluminum disk having a diameter of 50 mm was pressed against the surface of the toner supplying roller to determine the required magnitude of repulsion force for 1 mm deformation at the surface.

By controlling the characteristics of a toner supplying roller, the cell diameter of the toner supplying roller and a toner particle diameter in appropriate levels, it is possible to prevent occurrence of nonuniformity of image density and image streaks when forming images. The fixing performance in an oil-less fixing process utilizing application of heat can be improved the plasticity of resins used in a toner. The technique can be suitably used in a variety of electrophotographic systems and processes.

### EXAMPLES

Hereinafter, with referring to Examples and Comparative Examples, the present invention will be further explained in detail; however, these examples should not be construed as limiting the scope of this invention. The term “part” or “parts” in Examples and Comparative Examples refers to “part by mass” or “parts by mass”.

### <Production of Feeding Roller>

### Production Example 1

(1) 100 parts of ED-37B of PPG-Diol series (polyether polyol having a number average molecular weight of 3,000, manufactured by Mitsui Takeda Chemical Inc.) as polyol

(2) 33 parts of MDI (MILLIONATE MTL-S, manufactured by NIPPON POLYURETHANE INDUSTRY CO., LTD.) as isocyanate

(3) 0.3 parts of KAOLIZER No. 23 NP (manufactured by Kao Corporation) as an amine catalyst

(4) 4 parts of EP 73660A (manufactured by PAN TECHNOLOGY Inc.) as an organic acid salt catalyst

(5) 1 part of ion exchange water

(6) 8 parts of Niaxsilicone L5614 (straight chain dimethyl polysiloxane, manufactured by GE Silicones Inc.) as a foam stabilizer All of the above-stated components except for isocyanate were mixed and kneaded together. Then, isocyanate was added to and mixed with the resulting mixture. The thus obtained mixture was poured into a die, foamed, and hardened. Thereby a polyurethane foam was formed. The resulting polyurethane foam was formed into a specified shape. Thus a toner supplying roller R1 was obtained. The average cell diameter (μm) and hardness (g/mm) at the surface of the toner supplying roller R1 was measured. The results are shown in Table 1.

### Production Example 2

A toner supplying roller R2 was obtained in the same manner as in Production Example 1 except that the amount of isocyanate was reduced to 24 parts, the amount of the amine catalyst was reduced to 0.25 parts, and the amount of the ion exchange water was reduced to 0.5 parts.

### Production Example 3

A toner supplying roller R3 was obtained in the same manner as in Production Example 1 except that the amount of isocyanate was increased to 38 parts, the amount of the amine catalyst was increased to 0.4 parts, and the amount of the ion exchange water was increased to 1.5 parts.

### Production Example 4

A toner supplying roller R4 was obtained in the same manner as in Production Example 1 except that the amount of isocyanate was reduced to 20 parts, the amount of the amine catalyst was reduced to 0.1 parts, and the amount of the ion exchange water was reduced to 0.3 parts.

### Production Example 5

(1) 100 parts of VORANOL3022 (polyol having a weight-average molecular weight of 3,000, manufactured by Dow Chemical Japan)

(2) 48 parts of Sumidur 44V10 NC 31% (isocyanate manufactured by Sumitomo Bayer Urethane)

(3) 10 parts of 1,4-butanediol as a cross-linking agent

(4) 0.1 parts of KAOLIZER No. 31 (manufactured by Kao Corporation) as a catalyst

(5) 0.01 parts of NEOSTAN U-100 (dibutyl tin dilaureate) as a catalyst

(6) 1 part of ion exchange water

(7) 8 parts of L520 (a silicone foam stabilizer manufactured by Nippon Unicar Company Limited) as a foam stabilizer

A mixture of the above-stated components was mixed and kneaded with dried air (where the volume of dried air was 170 ml per 100 g of the mixture). Subsequently, the resulting mixture was poured into a die, foamed, and hardened. Thereby polyurethane foam was formed. The resulting polyurethane foam was formed into a specified shape. Thus a toner supplying roller R5 was obtained.

### Production Example 6

(1) 100 parts of a copolymer of epichlorohydrin

(2) 3 parts of hydrotalcite

(3) 12 parts of azodicarbonamide, or ADCA, as a foaming agent

(4) 1 parts of urea as an auxiliary foaming agent

A mixture of the above-stated components was mixed and kneaded. Subsequently, the resulting mixture was poured into a die, foamed, and hardened. Thereby polyurethane foam was formed. The resulting polyurethane foam was formed into a specified shape. Thus a toner supplying roller R6 was obtained.

<Production of Toner>

### Production Example 1 for Toner

<Synthesis of Polyester Resin>

In a reaction vessel equipped with a condenser tube, a stirrer and a nitrogen inlet tube, a mixture of the following compounds was placed: 553 parts of bisphenol A ethylene oxide dimolar adduct; 196 parts of bisphenol A propylene oxide dimolar adduct; 220 parts of terephthalic acid; 45 parts of adipic acid; and, 2 parts of dibutyl tin oxide. The components were reacted at 230° C. under atmospheric pressure for 8 hours, and further reacted under a reduced pressure of 10 mmHg to 15 mmHg for 5 hours. Subsequently, 26 parts of trimellitic anhydride was placed in the vessel. The resulting mixture was reacted at 180° C. under atmospheric pressure for 2 hours. Thus Polyester Resin 1 was obtained. The thus obtained Polyester Resin 1 had a number-average molecular weight of 2,200, a weight-average molecular weight of 5,600, a glass transition temperature (Tg) at 43° C., and an acid value of 13 mgKOH/g.

<Synthesis of Vinyl Copolymer>

In a reaction vessel equipped with a condenser tube, a stirrer and a nitrogen inlet tube, a mixture of 1.6 parts of dodecyl sodium sulfate and 492 parts of ion exchange water was placed. The mixture was heated to 80° C. Subsequently, a solution obtained by dissolving 2.5 parts of potassium persulfate (or KPS) into 100 parts of ion exchange water was placed in the vessel. Into the vessel, 15 minutes after the placing of the solution, a mixture solution composed of the following compounds was added dropwisely in 90 minutes: 140 parts of styrene (St); 30 parts of butyl acrylate (BA); 30 parts of methacrylic acid (MA); and, 7.6 parts of n-octyl mercaptan (NOM) as a molecular weight adjusting agent. Then, the resulting mixture was kept at 80° C. for 60 minutes. It was cooled down, and thereby dispersed solution of particles S-1 containing vinyl copolymer was obtained. The average diameter of the particles S-1 was 87 nm. A small amount of the dispersed solution was taken and placed on a petri dish, and the dispersion media contained therein was evaporated to observe a solid product. The solid product had a mass average molecular weight (Mw) of 8,300, and a glass transition temperature (Tg) at 69° C.

<Synthesis of Prepolymer>

In a reaction vessel equipped with a condenser tube, a stirrer and a nitrogen inlet tube, a mixture of the following compounds was placed: 682 parts of bisphenol A ethylene oxide dimolar adduct; 81 parts of bisphenol A propylene oxide dimolar adduct; 283 parts of terephthalic acid; 22 parts of trimellitic anhydride; and, 2 parts of dibutyl tin oxide. The components were reacted at 230° C. under atmospheric pressure for 8 hours, and further reacted under a reduced pressure of 10 mmHg to 15 mmHg for 5 hours. Thus intermediate polyester resin 1 was obtained. The intermediate polyester resin 1 had a number average molecular weight of 2,100, weight average molecular weight of 9,500, glass transition temperature at 55° C., acid value of 0.5 mgKOH/g, and hydroxyl value of 49 mgKOH/g.

Subsequently, in a reaction vessel equipped with a condenser tube, a stirrer and a nitrogen introducing tube, a mixture of the following compounds was placed; 411 parts of the intermediate polyester resin 1; 89 parts of isophorone diisocyanate; and, 500 parts of ethyl acetate. The components were reacted at 100° C. under atmospheric pressure for 5 hours. Thereby Prepolymer 1 was obtained. The content of free isocyanate groups in Prepolymer 1 was 1.53% by mass.

<Production of Masterbatch 1K>

The following components were mixed with a HENSCHEL Mixer: 40 parts of Special Black REGAL 400R (a carbon black manufactured by Cabot Corp.); 60 parts of RS-801 (a polyester resin having an acid value of 10 mgKOH/g, a weight-average molecular weight of 20,000 and glass transition temperature at 64° C., manufactured by Sanyo Chemical Industries, Ltd.); and, 30 parts of water. The thus obtained mixture was kneaded using a two-roller kneading machine (where the surface temperature of the rollers was set at 130° C.) for 45 minutes. Then, the thus obtained kneaded-article was pulverized into 1 mm particles using a pulverizer. Thereby Masterbatch 1K was obtained.

<Preparation of Dispersed Solution (Oil Phase) of Pigment and Releasing Agent>

In a container equipped with a stirrer and thermometer, the following components were placed: 543.5 parts of Polyester Resin 1; 181 parts of carnauba wax; and 1,450 parts of ethyl acetate. They were heated to 80° C. while stirred, and kept at that temperature for 5 hours. Subsequently, they were cooled down to 30° C. in 1 hour. Then, 500 parts of Masterbatch 1K and 100 parts of ethyl acetate were placed in the container. The resulting mixture was stirred hour 1 hour. Thereby Material Dissolved Solution 1 was obtained.

In a container, 1,500 parts of Material Dissolved Solution 1 was placed. Then, using Ultra Visco Mill (a bead mill manufactured by IMEX CORPORATION) filled with 80% by volume of 0.5 mm zirconia beads and 3 times of dispersing treatments, the carbon black and the releasing agent were dispersed under the following conditions: feeding rate of 1 kg/hour; and, disc circumferential speed of 6 m/second. Then, 655 parts of ethyl acetate solution of 65% by mass of Polyester Resin 1 was added to the dispersed product. The resulting mixture was dispersed once with the bead mill under the same condition as stated above at 130° C. for 30 minutes. Ethyl acetate was added to the mixture such that the solid content concentration of the mixture was adjusted to 50% by mass. Thereby Dispersed Solution 1 of pigment and releasing agent was obtained.

<Preparation of Water Phase>

The following components were mixed and kneaded, and thereby Water Phase 1 in milky white color was obtained: 968 parts of ion exchange water; 40 parts of hydrophilic dispersed solution of 25% by mass of a copolymer (the copolymer of styrene-methacrylic acid-acrylic acid butyl-sodium salt of methacrylic acid sulfuric ester of ethyleneoxide adduct) as a dispersion stabilizer; 150 parts of Eleminole MON-7 (an aqueous solution of 48.5% by mass of dodecy diphenylether sodium disulfonate); and 98 parts by mass of ethyl acetate.

<Emulsification>

Using a TK HOMOMIXER (a mixer manufactured by PRIMIX Corporation), 976 parts of Dispersed Solution 1 of pigment and releasing agent and 2.6 parts of isophorone diamine as an amine were mixed at 5,000 rpm for 1 minute. Then, 88 parts of Prepolymer 1 was added to the mixture, and they were further mixed with the TK HOMOMIXER at 5,000 rpm for 1 minute. Subsequently, 1,200 parts of Water Phase 1 was added to the mixture, and they were mixed with TK HOMOMIXER at the number of rotations adequately adjusted in the range of from 8,000 rpm to 13,000 rpm for 20 minutes. Thereby Emulsified Slurry 1 was obtained.

<Desolventization>

The obtained Emulsified Slurry 1 was placed in a container equipped with a stirrer and thermometer, and was desolventized at 30° C. for 8 hours. Thereby Dispersed Slurry 1-1 was obtained.

<Adhesion of Fine Particles>

To Dispersed Slurry 1-1, 20% by mass of the dispersed solution of particles S-1 was added based on the total solid content of Dispersed Slurry 1-1. The resulting solution was heated to 73° C. in 30 minutes. the solution was kept at 73° C. While kept at that temperature, solution obtained by dissolving 100 parts of magnesia chloride 6-hydrate into 100 parts by mass of ion exchange water was added little by little to the solution. Four hours later, the pH of the solution was adjusted to 5 by adding an adequate amount of a hydrochloride solution, and then the resulting solution was heated to 80° C. and kept at the temperature for 2 hours. Subsequently, the solution was cooled down, and thereby Dispersed Slurry 1-2 was obtained.

<Cleaning and Drying>

To obtain Filtered Cake 1K, 100 parts of Dispersed Slurry 1-2 was subjected to vacuum-pressure filtering to obtain a filtered cake, and the following processes were performed to the filtered cake:

(1) 100 parts of ion exchange water was added to the filtered cake. The resulting mixture was mixed using TK HOMOMIXER at 12,000 rpm for 10 minutes, and then it was subjected to vacuum pressure filtering.

(2) 900 parts of ion exchange water was added to the filtered cake treated in (1). The resulting mixture was given ultrasonic vibration while mixed with TK HOMOMIXER at 12,000 rpm for 30 minutes to obtain slurry solution. The slurry solution was then subjected to vacuum pressure filtering. The slurry solution was repeatedly subjected to vacuum pressure filtering until its electrical conductance reached 10 μC/cm or lower.

(3) 10% by mass of hydrochloride was added to the slurry solution obtained in (2) in order to adjust the pH thereof at 4. The resulting solution was mixed with Three-One Motor for 30 minutes and was subjected to filtering to obtain a filtered cake.

(4) 100 parts of ion exchange water was added to the filtered cake obtained in (3). The resulting mixture was mixed with a TK HOMOMIXER at 12,000 rpm for 10 minutes to obtain slurry solution. The slurry solution was then subjected to vacuum pressure filtering. The slurry solution was repeatedly subjected to the process (4) until its electrical conductance reached 10 ∞C/cm or lower. Thereby Filtered Cake 1 was obtained.

The thus obtained Filtered Cake 1 was dried at 45° C. for 48 hours in a shield type dryer, and the thus obtained articles were sieved with a mesh having openings of 75 μm. Thereby Coloring Particles 1K were obtained. Coloring Particles 1K had a volume average particle diameter (Dv) of 5.7 μm.

<Deposition of External Additives>

With FM20C/I (a HENSCHEL Mixer manufactured by Mitsui Mining Corporation), the following toner components were mixed for 5 hours to obtain toner: 100 parts of Coloring Particles 1K; 0.5 parts of a hydrophobitic silica having a BET specific surface area of 200 m²/g; and, 0.5 parts of another hydrophobitic silica having a BET specific surface area of 50 m²/g. An upper Blade A0 and a lower blade ST were used in FM20C/I, where the circumferential velocity at the tip of the lower blade was set at 40 m/s.

### Production Example 2 for Toner

A toner of Production Example 2 was obtained in the same manner as in Production Example 1 for toner except that the amount of added isophorone diamine was adjusted so that the volume average particle diameter (Dv) of the toner was 8.5 μm.

For the respective thus obtained toners (of Production Examples 1 and 2), the following evaluations were performed. The results are shown in Table 1-B.

### (Nonuniformity in Image Density)

Using an image forming apparatus that had been remodeled from IPSIO CX2500 manufactured by Ricoh Company Ltd., 2,000 sheets of a given print pattern with a print ratio of 6% were continuously printed under room temperature (23° C.)/normal humidity (45% RH). The IPSIO CX2500 was remodeled such that the touching area of development and toner supplying rollers were changeable. Further, 2,000 sheets of an image of solid part with a print ratio of 100% were printed under the same environment as used in the above. Then, the printed images were evaluated based on the following criteria.

A: Nonuniformity in image density was not recognized

B: Although nonuniformity in image density was somewhat recognized, the result was acceptable in practice.

C: Nonuniformity in image density was recognized in at least one of respectively printed sheets, and the result was unacceptable in practice.

### (Occurrence of Streak)

In the same manner as in the evaluation of nonuniformity in image density, 2,000 sheets of a print pattern with a print ratio of 6% were continuously printed. Thereafter, 2,000 sheets of an image of solid part with a print ratio of 100% were printed under the same environment as used in the above. The evaluation of occurrence of streaks on the images carried out based on the following criteria.

A: Streaks were not recognized

B: Although the generation of streaks on image was somewhat recognized, it was acceptable in practice.

C: The generation of streaks was recognized on at least one of respectively printed sheets, and the result was unacceptable in practice.

### (Background Smear)

In the same manner as in the evaluation of nonuniformity in image density, 2,000 sheets of a print pattern with a print ratio of 6% were continuously printed. Thereafter, 2,000 sheets of an image of solid part with a print ratio of 100% were printed under the same environment as used in the above. The evaluation of occurrence of background smear on the images was carried out based on the following criteria.

A: No background smear was recognized

B: Although the occurrence of background smear was somewhat recognized, it was acceptable in practice.

C: Occurrence of background smear was recognized in at least one of respectively printed sheets, and the result was unacceptable in practice.

The above-stated evaluations were also performed for Examples 2 to 7 and Comparative Examples 1 to 5. The results are shown in Table 1-B.

TABLE 1-A

| | Toner supplying roller | | | | | Toner | | | | |
|---|---|---|---|---|---|---|---|---|---|---|
| | | | Average | | | Average particle | | | | |
| | | Roller | cell | | | diameter | | | Average | |
| | | diameter | diameter | Hardness | Formability | Dv | Dn | | Degree of | Tm |
| | Roller | mm | μm | g/mm | — | (μm) | (μm) | Dv/Dn | Circularity | ° C. |
| Example 1 | R1 | 10 | 360 | 180 | A | 5.7 | 5.0 | 1.14 | 0.97 | 129 |
| Example 2 | R2 | 10 | 250 | 200 | A | 5.7 | 5.0 | 1.14 | 0.97 | 129 |
| Example 3 | R3 | 10 | 420 | 180 | A | 5.7 | 5.0 | 1.14 | 0.97 | 129 |
| Example 4 | R1 | 10 | 350 | 180 | A | 8.5 | 7.5 | 1.13 | 0.97 | 128 |
| Example 5 | R3 | 10 | 420 | 180 | A | 8.5 | 7.5 | 1.13 | 0.97 | 128 |
| Example 6 | R4 | 10 | 200 | 300 | A | 8.5 | 7.5 | 1.13 | 0.97 | 128 |
| Comp. Ex. 1 | R5 | 10 | 150 | 420 | A | 5.7 | 5.0 | 1.14 | 0.97 | 129 |
| Comp. Ex. 2 | R6 | 10 | 550 | 180 | A | 5.7 | 5.0 | 1.14 | 0.97 | 129 |
| Comp. Ex. 3 | R2 | 10 | 260 | 200 | A | 8.5 | 7.5 | 1.13 | 0.97 | 128 |
| Comp. Ex. 4 | R5 | 10 | 150 | 420 | A | 8.5 | 7.5 | 1.13 | 0.97 | 128 |

TABLE 1-B
Evaluation result

| Nonuniformity in | Occurrence of | |
|---|---|---|
| image density | streaks | Background smear |
| A | A | A |
| A | A | A |
| A | A | A |
| A | A | A |
| A | A | A |
| A | A | A |
| C | C | C |
| A | C | C |
| C | A | A |
| C | C | C |

What is claimed is:

1. An image forming method, comprising:
supplying a toner to a developing roller using a toner supplying roller, and
forming an image by the use of a one-component developer,
wherein the toner supplying roller comprises a polyurethane foam and is 5 mm to 12 mm in diameter, the polyurethane foam has an repulsion force of 100 g/mm to 400 g/mm, and the average cell diameter, or Dc, of the polyurethane foam and the volume average particle diameter, or Dt, of the toner satisfy the following mathematical expressions:
4≦Dt≦10
30Dt+50≦Dc≦30Dt+300
where Dt and Dc are in micrometer.

2. The image forming method according to claim 1, wherein the developing roller makes contact with the toner supplying roller, and and the contact portion is formed such that the surface of the toner supplying roller has concave portions.

3. The image forming method according to claim 1, wherein the developing roller is larger in diameter and has a smaller circumferential velocity than the toner supplying roller.

4. The image forming method according to claim 1, wherein the developing roller rotates in the counter direction to the rotational direction of the toner supplying roller.

5. The image forming method according to claim 1, wherein the polyurethane foam comprises at least a polyol, an isocyanate, a catalyst and a foaming agent.

6. The image forming method according to claim 1, wherein the toner comprises at least a binder resin, a colorant and a releasing agent.

7. An image forming apparatus, comprising:
a developing roller, and
a toner supplying roller configured to feed a toner to the surface of the developing roller to thereby form an image by the use of a one-component developer,
wherein the toner supplying roller comprises a polyurethane foam and is 5 mm to 12 mm in diameter, the polyurethane foam has an repulsion force of 100 g/mm to 400 g/mm, and the average cell diameter, or Dc, of the polyurethane foam and the volume average particle diameter, or Dt, of the toner satisfy the following mathematical expressions:
4≦Dt≦10
30Dt+50≦Dc≦30Dt+300
where Dt and Dc are in micrometer.

8. The image forming apparatus according to claim 7, wherein the developing roller makes contact with the toner supplying roller, and the contact portion is formed such that the surface of the toner supplying roller has concave portions.

9. The image forming apparatus according to claim 7, where in the developing roller is larger in diameter and has a smaller circumferential velocity than the toner supplying roller.

10. The image forming apparatus according to claim 7, wherein the developing roller rotates in the counter direction to the rotational direction of the toner supplying roller.

11. The image forming apparatus according to claim 7, wherein the polyurethane foam comprises at least a polyol, an isocyanate, a catalyst and a foaming agent.

12. The image forming apparatus according to claim 7, wherein the toner comprises at least a binder resin, a colorant and a releasing agent.

13. A process cartridge, comprising:
a developing unit
wherein the developing unit comprises a developing roller and a toner supplying roller configured to supply a toner to the surface of the developing roller, the developing roller and the toner supplying is roller are integrated into a one unit and is detachably mountable to the main body of an image forming apparatus; the toner supplying roller comprises a polyurethane foam and is 5 mm to 12 mm in diameter, the polyurethane foam has an repulsion force of 100 g/mm to 400 g/mm, and the average cell diameter, or Dc, of the polyurethane foam and the volume average particle diameter, or Dt, of the toner satisfy the following mathematical expressions:
4≦Dt≦10
30Dt+50≦Dc≦30Dt+300
where Dt and Dc are in micrometer.

14. The process cartridge according to claim 13, wherein the developing roller makes contact with the toner supplying roller, and the contact portion is formed such that the surface of the toner supplying roller has concave portions.

15. The process cartridge according to claim 13, wherein the developing roller is larger in diameter and has a smaller circumferential velocity than the toner supplying roller.

16. The process cartridge according to claim 13, wherein the developing roller rotates in the counter direction to the rotational direction of the toner supplying roller.

17. The process cartridge according to claim 13, wherein the polyurethane foam comprises at least a polyol, an isocyanate, a catalyst and a foaming agent.

18. The process cartridge according to claim 13, wherein the toner comprises at least a binder resin, a colorant and a releasing agent.
